(19) United States
(12) Patent Application Publication
(10) Pub. No.: US 2003/0231649 A1
(43) Pub. Date: Dec. 18, 2003

(54) Dual purpose method and apparatus for performing network interface and security transactions

(76) Inventors: Paul A. Awoseyi, Katy, TX (US); David J. Koenen, Round Rock, TX (US); Ignacio Cartagena, Cypress, TX (US); Mark M. Mitchum, Cypress, TX (US)

Correspondence Address: Michael G. Fletcher, Fletcher, Yoder & Van Someren, P.O. Box 692289, Houston, TX, 77269-2289, US

(21) Appl. No.: 10/170,521

(22) Filed: Jun. 13, 2002

(51) Int. Cl. H04L 12/66; H04J 3/16

(52) U.S. Cl. 370/463; 370/465; 713/200

(57) ABSTRACT

A technique for processing data packets in a network. Specifically, an expansion card is provided for a computer system. The expansion card is configured to be inserted into a computer system to facilitate network interface functions and security functions. By providing chipsets to perform network interface functions and security functions, on a single expansion card, secured data exchange over a network, such as the Internet, may be facilitated more efficiently.

### BACKGROUND OF THE INVENTION

1. Field of the Invention

This invention relates generally to computer systems and, more particularly, to a method and apparatus for performing network interface functions and security transactions.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Personal computers and workstations are virtually indispensable in today's high-tech environment. While distinctions between “personal computers” and “workstations” may exist, the terms may be used interchangeably for the purposes of the present disclosure, herein. Computer systems rely on processors, associated chipsets, and memory devices to perform a variety of applications, processes, and requests. Although personal computers and workstations are both designed as single-user systems, it is common to link personal computers/workstations together to form a network, such as a local-area network (LAN). Each personal computer/workstation, or “node,” in the LAN has its own host processor or central processing unit (CPU) with which it executes programs. Each node is also able to access data and devices anywhere on the LAN, thus enabling users to share data and expensive devices, such as laser printers. Further, users at each personal computer/workstation can also use the LAN to communicate via email. Although there are many different types of LANs, Ethernets are the most commonly used for personal computer and workstation connectivity.

To facilitate connection to internal networks or the Internet, computers generally use a network interface card (NIC) which is an adapter card that can be inserted into the computer to facilitate the exchange of information via the network (Ethernet). Typically, most NICs are designed to support a particular type of network topology, protocol, and media, although some can support multiple protocols. NICs are generally plugged into the bus of the computer or workstation via an expansion slot. Most computers or workstations include expansion slots for adding memory, graphic adapters, and support for special devices. An adapter card, such as a NIC, may be inserted into an expansion slot to facilitate the exchange of information over the Internet. A typical NIC may have one or more chipsets on it to handle the normal network I/O activities of the personal computer or workstation.

One desirable feature of many NICs is the ability to exchange information via the Internet, for example. While NICs generally facilitate the exchange of information and the movement of data via the Internet, they normally do not provide a mechanism for data security for secure web pages. With the dramatic increase in e-commerce and e-business transactions there is an increased demand for secured data transmissions requiring data authentication, encryption, decryption, data security, data verification, and data integrity. Disadvantageously, the desirability of secured transactions has led to increased demands on limited system resources.

Currently, one mechanism for facilitating the secured exchange of information is to allow the host processor to perform the compute-intensive transactions associated with data security, such as data authentication, data encryption, data decryption, etc. However, because of the compute-intensive exponential calculations associated with secured transactions, a host processor may become overwhelmed with performing security and data integrity functions that may disadvantageously impact the overall system performance. One of the methods for off-loading the security transactions is to provide a security card to plug into an expansion slot in the computer system to offload the security functions. A variety of chipsets are available on expansion boards which may be used to provide security processing. However, many computers such as the ProLiant DL320, and other servers for instance, only include a single expansion slot. Since a network interface card may necessarily occupy the single expansion slot to facilitate network communication, there may be no expansion slot available for a security card. For systems that include more than one expansion slot, other expansion boards may be occupying all of the available slots necessary and may render the addition of a separate expansion card for security difficult. Further, even if there are available expansion slots, such that one card can occupy one slot to handle normal network I/O activities and a separate card can occupy a second expansion slot to handle compute-intensive secured transactions, this approach is costly, inefficient, less scalable, and unwieldy to implement on thin servers such as 1U blade servers where real estate and CPU resources are at a minimum.

The present techniques may be directed to one or more of the problems set forth above.

### BRIEF DESCRIPTION OF THE DRAWINGS

The foregoing and other advantages of the invention will become apparent upon reading the following detailed description and upon reference to the drawings in which:

FIG. 1 illustrates a block diagram of an exemplary computer system;

FIG. 2 illustrates a block diagram of a dual-purpose device to perform normal network I/O activities and security processing in accordance with the present technique; and

FIG. 3 is a flow chart illustrating the present technique for handling network data.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

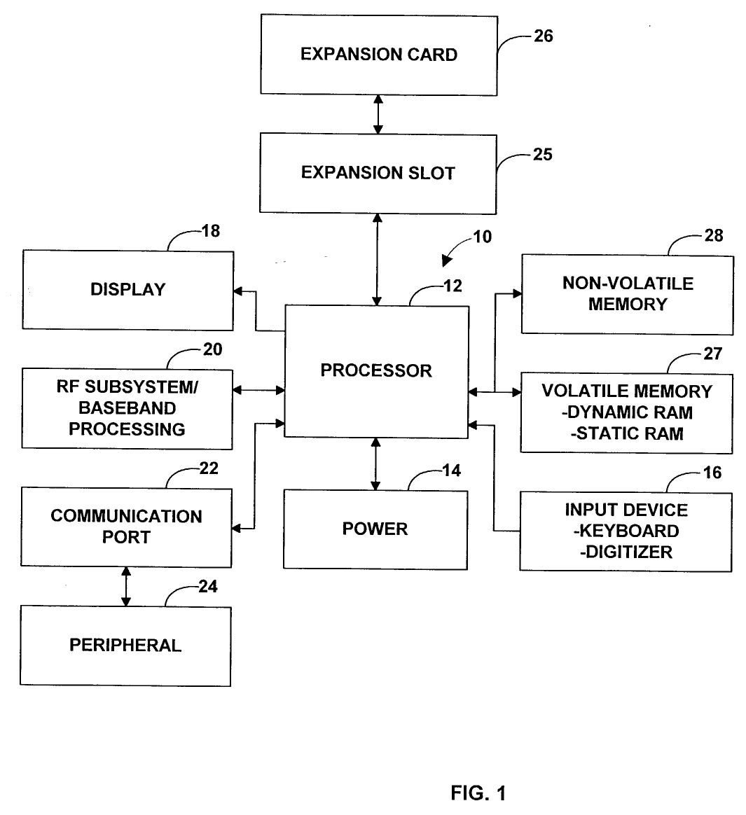

Turning now to the drawings, and referring initially to FIG. 1, a block diagram depicting an exemplary processor-based device, generally designated by the reference numeral 10, is illustrated. The device 10 may be any of a variety of different types, such as a computer, pager, cellular telephone, personal organizer, control circuit, etc. In a typical processor-based device, a processor 12, such as a microprocessor, controls many of the functions of the device 10. The processor 12 may comprise a plurality of processors.

The device 10 typically includes a power supply 14. For instance, if the device 10 is portable, the power supply 14 would advantageously include permanent batteries, replaceable batteries, and/or rechargeable batteries. The power supply 14 may also include an A/C adapter, so that the device may be plugged into a wall outlet, for instance. In fact, the power supply 14 may also include a D/C adapter, so that the device 10 may be plugged into a vehicle's cigarette lighter, for instance.

Various other devices may be coupled to the processor 12, depending upon the functions that the device 10 performs. For instance, a user interface 16 may be coupled to the processor 12. The user interface 16 may include buttons, switches, a keyboard, a light pen, a mouse, and/or a voice recognition system, for instance. A display 18 may also be coupled to the processor 12. The display 18 may include an LCD display, a CRT, LEDs, and/or an audio device.

Furthermore, an RF subsystem/baseband processor 20 may also be coupled to the processor 12. The RF subsystem/baseband processor 20 may include an antenna that is coupled to an RF receiver and to an RF transmitter (not shown). A communication port 22 may also be coupled to the processor 12. The communication port 22 may be adapted to be coupled to a peripheral device 24, such as a modem or a printer, for instance, or to a network such as a local area network (LAN), an intranet and/or the Internet. The device 10 may also include an expansion slot 25 configured to receive an expansion card 26, such as a network interface card (NIC), which may be used to facilitate the exchange of information over a network, such as a LAN.

Because the processor 12 controls the functioning of the device 10 generally under the control of software programming, memory is coupled to the processor 12 to store and facilitate execution of one or more programs. For instance, the processor 12 may be coupled to volatile memory 27, which may include dynamic random access memory (DRAM) and/or static random access memory (SRAM). The processor 12 may also be coupled to non-volatile memory 28. The non-volatile memory 28 may include a read only memory (ROM), such as an EPROM, and/or Flash memory, to be used in conjunction with the volatile memory. The size of the ROM is typically selected to be just large enough to store any necessary BIOS operating system, application programs, and fixed data. The volatile memory, on the other hand, is typically quite large so that it can store dynamically loaded applications. Additionally, the non-volatile memory 28 may include a high capacity memory such as a disk or tape drive memory.

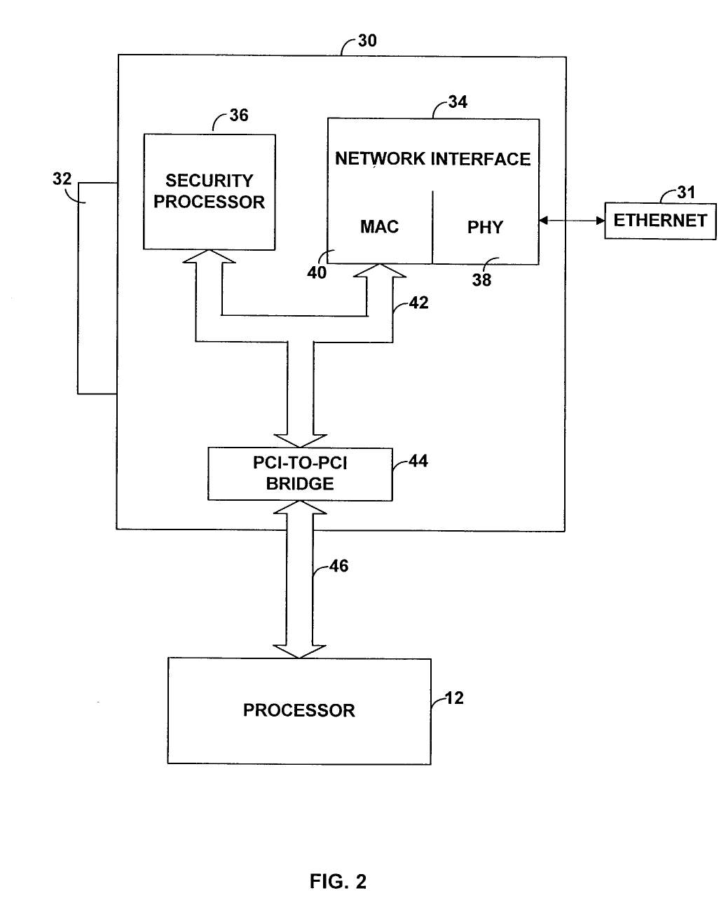

FIG. 2 illustrates a block diagram of an exemplary expansion card 26 that is insertable into the expansion slot 25 (FIG. 1). Specifically, a dual-purpose card 30 is illustrated. The card 30 facilitates normal network processing and exchange of information, as well as provides a mechanism for exchanging secured information. The card 30 may be used to provide access from the system 10 to a network such as the Ethernet Network 31. An edge connector 32 is configured such that the card 30 may be inserted into the expansion slot 25 of the computer. The card 30 includes one or more chips or chipsets to perform various functions. Specifically, in this example, the card 30 includes a network interface chipset 34 and a security processor chipset 36. As will be described further below, the network interface chipset 34 provides the interfacing functions necessary to exchange data packets on the Ethernet 31, while the security processor chipset 36 provides a mechanism for performing data security functions, such as encryption, decryption, data authentication for IP security (IPSec.) and Secure Socket Layer.

The network interface chipset 34 provides the networking framework for the card 30. The network interface chipset 34 may, for example, manipulates data in packets based on the Open System Interconnection (OSI) model. The mechanism of data transmission through the OSI protocol layers can be appreciated by those skilled in the art. Control is passed from one layer to the next during a data transfer. Of particular relevance to the present application is the physical layer (PHY) 38 and the media access control layer (MAC) 40. Each of the functions of the layers such as the PHY 38 and the MAC 40 may reside in a single chipset or separate chipsets. Various other layers may also be implemented in standard network interface control devices, as can be appreciated by those skilled in the art. While additional layers are not illustrated herein, it is clear that the card 30 and more specifically, the network interface chipset 34, may implement other layers and chipsets to facilitate the exchange of information on the Ethernet 31. However, for the purpose of this discussion, only the PHY 38 and the MAC 40 are illustrated.

The Ethernet 31 is a network topology with a PHY 38 component. The PHY 38 conveys the bit stream through the network at the electrical and mechanical level and provides the hardware means of sending and receiving on a carrier, including defining cables, cards and physical aspects.

The media access control layer (MAC) 40 is one of two sub-layers that make up the data link layer of the OSI model. The MAC 40 is responsible for moving data packets to and from one card, such as the card 30, to another card across a shared channel. The MAC sub-layer uses MAC protocols to ensure that signals sent from different stations across the same channel do not collide. The MAC 40, along with the logical link control (LLC) layer (the other sub-layer of the link layer of the OSI model—not shown), furnish transmission protocol knowledge and management and handle errors in the PHY, flow control and frame synchronization. Data packets are encoded and decoded into bits as they are passed from and to the PHY 38. The MAC 40 interfaces directly with the network media. Consequently, each different type of network media may implement a different MAC 40. The MAC 40 controls how a computer on a network gains access to the data and gains permission to transmit it.

The security processor chipset 36, also present on the card 30, provides a mechanism for processing secured transactions (authentication, encryption, data security, etc.) such that the host processor 12 is not burdened with the compute-intensive exercises associated with such secured transactions. The security processor chipset 36 can perform several types of encryptions: Internet protocol security (IPSec), secure sockets layer (SSL), etc. IPSec is a set of protocols developed to support the secured exchange of data packets. As understood by those skilled in the art, each data packet (or the data packet along with its corresponding header) may be encrypted and decrypted by sending and receiving devices that share a public key. The SSL protocol also uses a public key to encrypt data that is transferred across the network infrastucture. However, whereas IPSec encrypts each individual data packet, SSL creates a secure connection between a client and a server, over which any amount of data can be sent securely without individually encrypting each data packet.

To provide SSL security, transmission control protocol (TCP) may be implemented. Most networks combine Internet protocol (IP) along with the higher level TCP to provide a suite of communications protocols used to connect a host device, such as the device 10, to the Network infrastructure. Whereas the IP protocol deals only with data packets, the TCP is responsible for flow control and enables two hosts to establish a connection to exchange streams of data. TCP provides the delivery of data and also guarantees that packets will be delivered in the same order in which they are sent.

The specific details of the security processor chipset 36 may vary from system to system, depending on user needs. What is important for the purposes of the present techniques is that a security processor chipset 36 is provided on a single card 30 along with the network interface chipset 34 such that both chipsets can be implemented through the use of a single expansion slot 25 or embedded on the motherboard (planar board). A bus, such as a PCI bus 42 may be provided to electrically couple the network interface chipset 34 to the security processor chipset. Further, the PCI bus 42 may be coupled to a bridge on the card 30, such as a PCI-to-PCI bridge 44. The bridge 44 may be used to forward data packets to the processor 12 via a bus, such as a PCI bus 46. Other alternative interconnect buses between network and security processor chipsets include: POSPHY and CSIX.

As previously discussed, in the present embodiment there are two types of encryptions that the card 30 can perform, IPSec and SSL. Incoming IPSec packets from the Ethernet 31 can be recognized by the MAC 40 and forwarded to the security processor 36, via the PCI bus 42, for decryption. Likewise, for encryption, outgoing packets are sent from the PCI-to-PCI bridge 44 to the security processor 36, via the PCI bus 42 for encryption and then forwarded to the MAC 40 for transmission out on the Ethernet 31. The SSL encryption/decryption is performed deeper in the packet which may require additional TCP/IP processing by the host processor 12 before recognizing the encrypted message. Thus, data packets may be delivered to the processor 12 and later forwarded to the security processor 36 for decryption, after the encryption is recognized by the processor 12. Likewise, unsecured web-pages could be encrypted by the security processors SSL function prior to TCP/IP encapsulation. The encapsulated packet would be processed by the MAC 40 as in typical network transaction processing.

Essentially, a network interface chipset 34, as may be implemented in a typical system, is enhanced with a security processor chipset 36. The security processor chipset 36 handles the compute-intensive security functions. If real estate on the card 30 is an issue, the security processor chipset 36 may be fabricated on a daughter-card that can be coupled to the card 30 which includes the network interface chipset 34. Advantageously, the daughter-card does not require an additional expansion slot 25 and therefore does not implement a separate edge connector. The daughter-card is electrically coupled to the card 30 such that the network interface chipset 34 can exchange information with the security processor chipset 36 without initiating the host processor 12.

Regardless of whether the security processor chipset 36 is included on the card 30 or is included on a separate daughter-card, or embedded on the motherboard, the device will significantly enhance scalability of the server, boost overall system performance, and reduce PCI bus, host bus, and CPU utilization. This technique can readily be implemented in dense, rackmounted thin blade servers for example, where real estate is limited or any other server.

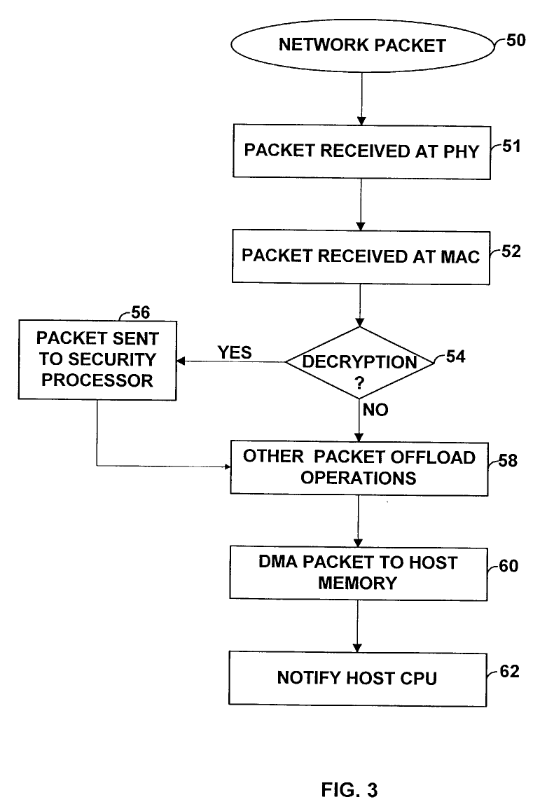

FIG. 3 illustrates an exemplary process flow implementing the card 30 including the network interface chipset 34 and the security processor chipset 36. A network packet 50 is sent via the Ethernet 31 and delivered to the network interface chipset 34. The network packet 50 is received by the PHY layer 38 and passed to the MAC layer 40 as illustrated by blocks 51 and 52. The MAC layer 40 determines whether the network packet 50 requires decryption as illustrated by block 54. If the network packet requires decryption, it is sent to the security processor chipset 36, as illustrated in block 56. If the network packet 50 does not require decryption or other security functions, the network interface chipset 34 may perform other networking functions as illustrated in block 58. Once the network interface chipset 34 is finished with the network packet 50, it is delivered to host memory via the PCI-to-PCI bridge 44, as indicated in block 60. Finally, the dual-purpose card notifies the host processor 12 that the packet is ready for host processing.

If the network packet 50 requires IPSec security processing, and is delivered to the security processor chipset 36 as indicated in block 56, the security processor chipset 36 will perform the required security functions (e.g., IPSec decryption) and deliver the decrypted network packet to the host memory 27 space reserved for the incoming Ethernet packets. From there, the decrypted network packet is processed like a normal network packet that did not require host CPU 12 security processing. Thus, the security processor chipset 36 delivers the decrypted network packet to the PCI-to-PCI bridge 44 and onto the PCI bus 46 and into memory 27 for processing by the processor 12, as previously described. As should be clear from the flow chart, security processing can be performed in parallel with typical network processing. While network packets requiring security processing are offloaded to the security processor chipset 36, network packets not requiring security processing can be processed by the network interface chipset 34.

Alternatively, if the network packet 50 requires IPSec processing, and is delivered to the security processor chipset 36 as indicated in block 56, the security processor chipset 36 will perform the required security functions (e.g., decryption) and deliver the decrypted network packet back to the MAC layer of the network interface chipset 34 for further network packet processing like TCP Segmentation offload or Check sum offload. From there, the decrypted network packet is processed like a normal network packet that did not require security processing. Thus, the MAC 40 delivers the decrypted network packet to the PCI-to-PCI bridge 44 and onto the PCI bus 46 and into memory 27 for processing by the processor 12, as previously described. As should be clear from the flow chart, security processing can be performed in parallel with typical network processing as before.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A device comprising:
a first processor configured to perform network interface control functions;
a second processor coupled to the first processor and configured to facilitate secure data exchange; and
a single slot connector which is insertable into an expansion slot in a computer system and configured to electrically couple each of the first processor and the second processor to the computer system.

2. The device, as set forth in claim 1, wherein the device comprises a single expansion board on which each of the first processor, the second processor and the slot connector are disposed.

3. The device, as set forth in claim 1, wherein the first processor resides on a first card and the second processor resides on a second card, and wherein each of the first card and the second card are coupled to each other such that each of the first processor and the second processor utilize the single slot connector.

4. The device, as set forth in claim 1, wherein the second processor is configured to perform encryption and decryption of data pockets.

5. The device, as set forth in claim 1, wherein the second processor is configured to perform authentication of data pockets.

6. The device, as set forth in claim 1, wherein the second processor is configured to create a secure connection between the device and a server.

7. The device, as set forth in claim 6, wherein the second processor is configured to transmit and receive encrypted data via the Internet.

8. A computer system:
a host processor;
an expansion slot configured to receive an expansion board and configured to electrically couple the expansion board to the host processor; and
an expansion board comprising:
a first processor configured to perform network interface control functions;
a second processor coupled to the first processor and configured to facilitate secure data exchange; and
a single slot connector which is insertable into an expansion slot in a computer system and configured to electrically couple each of the first processor and the second processor to the computer system.

9. The computer system, as set forth in claim 8, comprising only one expansion slot.

10. The computer system, as set forth in claim 8, wherein the expansion board comprises a single expansion card on which each of the first processor, the second processor and the slot connector are disposed.

11. The computer system, as set forth in claim 8, wherein the first processor resides on a first card and the second processor resides on a second card, and wherein each of the first card and the second card are coupled to each other such that each of the first processor and the second processor utilize the single slot connector.

12. The computer system, as set forth in claim 8, wherein the second processor is configured to perform encryption and decryption of data pockets.

13. The computer system, as set forth in claim 8, wherein the second processor is configured to perform authentication of data pockets.

14. The computer system, as set forth in claim 8, wherein the second processor is configured to create a secure connection between the computer system and a server.

15. The computer system, as set forth in claim 14, wherein the second processor is configured to transmit and receive encrypted data via the Internet.

16. A method of processing network packets comprising the acts of:
receiving network packets at a network interface card, wherein the network packets comprise one of secured network packets and non-secured network packets, and wherein the network interface card comprises each of a network packet processor configured to process non-secured network packets and a security processor configured to process secured network packets;
receiving the network packets at the network packet processor;
transmitting the secured network packets from the network packet processor to the security processor; and
transmitting the non-secured network packets from the network packet processor to a corresponding target.

17. The method of processing network packets, as set forth in claim 16, wherein the act of transmitting the secured network packets comprises the act of transmitting encrypted network packets to the security processor.

18. The method of processing network packets, as set forth in claim 17, comprising the act of decrypting the encrypted network packets by the security processor to produce decrypted network packets.

19. The method of processing network packets, as set forth in claim 18, comprising the acts of:
transmitting the decrypted network packets from the security processor to the network packet processor; and
transmitting the decrypted network packets from the network packet processor to a corresponding target.

20. The method of processing network packets, as set forth in claim 16, wherein the act of receiving network packets at the network packet processor comprises the act of receiving network packets at a media access control (MAC) layer under the open system interconnection (OSI) model.
